(19) United States
(12) Patent Application Publication
(10) Pub. No.: US 2025/0006902 A1
(43) Pub. Date: Jan. 2, 2025

(54) OXIDE COMPOSITE POSITIVE ELECTRODE MATERIAL COATED WITH BORATE IN SITU, PREPARATION METHOD, AND USE

(71) Applicant: Institute of Physics, Chinese Academy of Sciences, Beijing (CN)

(72) Inventors: Yongsheng Hu, Beijing (CN); Zilin Hu, Beijing (CN); Yaoshen Niu, Beijing (CN); Yang Yang, Beijing (CN); Xiaohui Rong, Beijing (CN); Yaxiang Lu, Beijing (CN); Liquan Chen, Beijing (CN)

(21) Appl. No.: 18/708,882

(22) PCT Filed: Mar. 8, 2022
(86) PCT No.: PCT/CN2022/079725

§ 371 Date: May 9, 2024

(30) Foreign Application Priority Data
Nov. 12, 2021 (CN) 202111342367.8

(51) Int. Cl. H01M 4/36; C01G 53/00; H01M 4/02; H01M 4/505; H01M 4/525; H01M 4/58; H01M 10/054

(52) U.S. Cl. CPC H01M 4/366; C01G 53/50; H01M 4/505; H01M 4/525; H01M 4/5825; H01M 10/054; C01P 2002/22; C01P 2002/54; C01P 2002/72; C01P 2002/76; C01P 2004/03; C01P 2004/84; C01P 2006/40; H01M 2004/028

(57) ABSTRACT

An oxide composite positive electrode material coated with borate in situ, includes γAₓB_{y}O_{z}—NaₐLi_{b}Ni_{c}Cu_{d}MnₑM_{f}O_{2+β}. In the material, Li, Ni, Cu, Mn, and element M for doping and substituting a transition metal site together occupy the position of transition metal ions in the crystal structure. The space group of the layered oxide composite positive electrode material is P63/mmc or P63/mcm or R3̅m, or the corresponding structure is a P2 phase or an O3 phase. AₓB_{y}O_{z} is a coating layer that has a needle-like structure and is generated in situ on the surface of NaₐLi_{b}Ni_{c}Cu_{d}MnₑM_{f}O_{2+β}, being formed by, during a sintering process, coating a material precursor and a layered oxide precursor for generating NaₐLi_{b}Ni_{c}Cu_{d}MnₑM_{f}O_{2+β}; γ is the mass fraction of the coating material precursor in the layered oxide precursor, 0.1 wt %≤γ≤10 wt %; and A is Li and/or Na.

### CROSS-REFERENCE TO RELATED APPLICATIONS

This application is a national phase entry under 35 U.S.C. § 371 of International Patent Application PCT/CN2022/079725, filed Mar. 8, 2022, designating the United States of America and published as International Patent Publication WO 2023/082505 A1 on May 19, 2023, which claims the benefit under Article 8 of the Patent Cooperation Treaty of Chinese Patent Application Serial No. 202111342367.8, filed Nov. 12, 2021.

### TECHNICAL FIELD

The disclosure relates to the technical field of materials, in particular, to an oxide composite positive electrode material coated with borate in situ, a preparation method, and a use.

### BACKGROUND

With the continuous development and progress of society, there is growing demand for energy. However, the use of traditional fossil fuels like coal, oil, and natural gas is increasingly constrained due to resource depletion, aggravated urban environmental pollution, and the greenhouse effect. Consequently, the development of sustainable and clean energy sources has become the focus for nations worldwide. Nevertheless, the conversion of renewable energy sources such as wind power, solar energy, and tidal energy into electricity is significantly constrained by natural conditions and exhibits noticeable time discontinuity and uneven space distribution. This results in poor controllability and stability of the electricity they generate, making it challenging to directly integrate them into the power grid. Therefore, only high-performance large-scale energy storage systems can solve the time difference between power generation and electricity demand be addressed, and the electrical power quality regulated, in order to ensure reliable power supply in the electricity system. China is urgently in need of such large-scale energy storage technologies to support the sustainable development of its energy sector. The research focus on such technologies is also shared by countries worldwide.

Currently, there are two main categories of energy storage methods: physical energy storage and chemical energy storage. Physical energy storage includes methods such as pumped storage, compressed air energy storage, and flywheel energy storage. While pumped storage is the most widely used and has the largest energy storage capacity, its geographical limitations and long construction periods present certain challenges. On the other hand, other physical energy storage methods are still in the early stages of development and have not yet achieved large-scale implementation. Electrochemical energy storage involves the storage and release of electricity through reversible chemical reactions. It has gained significant attention due to its notable advantages, including high energy conversion efficiency, exceptional power density, extended cycle life, short construction periods, and low maintenance costs.

Currently, electrochemical energy storage includes various technologies, such as high-temperature Na—S batteries, flow batteries, lead-acid batteries, and lithium-ion batteries. Na—S batteries operate at around 300° C., utilizing molten metallic sodium and elemental sulfur. Their safety is a major concern as any damage to the materials at high temperatures can pose a significant risk of fire in battery modules, thereby restraining their large-scale application. Flow batteries have relatively low energy density and occupy significant volume. Lead-acid batteries, which dominate the energy storage market due to their low cost and absence of memory effect compared to Ni—Cd batteries, also have numerous drawbacks. These include high environmental pollution caused by lead, low energy density, heavy weight, large volume, and high maintenance costs. To address the requirement for low cost, environmental sustainability, long service life, and high safety performance in energy storage systems, lithium-ion secondary batteries and sodium-ion secondary batteries have become important technologies in energy storage.

At present, lithium-ion batteries are widely used as electrochemical energy storage devices in everyday life due to their high energy density, excellent cycle stability, long cycle life, compact size, lightweight nature, and lack of pollution. Sodium, belonging to the same alkali metal group as lithium in the periodic table of elements, shares similar physical and chemical properties. Sodium-ion batteries exhibit similar charging and discharging mechanisms as lithium-ion batteries. Moreover, sodium is abundantly available and widely distributed in nature, offering a significant cost advantage. In addition to the lower cost, sodium-ion batteries can utilize aluminum foil for both positive and negative current collectors, whereas copper is required only for the negative electrode in lithium-ion batteries, which is significantly more expensive than aluminum. Consequently, the low cost and easy availability of raw materials have attracted increasing global attention to sodium-ion batteries.

However, currently, sodium-ion batteries are still in the research stage, and there is no commercially available positive electrode material for sodium-ion batteries. Researchers are primarily focusing on the layered oxide positive electrode material NaₓMO₂ (where M represents 3d transition metal elements, which may include one or more of Ti, V, Cr, Fe, Mn, Co, Ni, Cu, Nb, Ru, Mo, and Zn). The fundamental principle of the battery lies in the redox reaction, which involves the transfer and deviation of electrons and, consequently, a change in valence. The oxidation reaction occurs when electrons are lost, resulting in an increase in the valence of the positive electrode material. Conversely, the reduction reaction occurs when electrons are gained, causing a decrease in valence in the positive electrode material. The aforementioned layered oxide positive electrode materials for sodium-ion batteries contain transition metal materials capable of undergoing redox reactions, and these variable-valency transition metals in their initial state exhibit a lower valence state. However, there are still many cases where transition metal ions cannot fully change their valence or utilize their capacity, and the insufficient air stability of these positive electrode materials leads to poor consistency.

### BRIEF SUMMARY

Embodiments of the disclosure provide an oxide composite positive electrode material coated with borate in situ, a preparation method, and a use. The positive electrode material possesses air stability, high capacity, and high cycle stability. Its coating layer exhibits a unique morphology, resembling needles upon exposure to air. Prior to air exposure, the coating layer adheres smoothly to the material surface. After coming into contact with air, the morphology of the coating layer undergoes a transition into a needle-like shape, leading to a significant reduction in residual alkali generated on the material surface due to air exposure. This transformation greatly enhances stability in an air environment, improves the electrical conductivity and sodium ion diffusion capacity of the material, reduces charge transfer impedance, increases initial charge-discharge efficiency, improves cycle ability, and notably extends cycle life.

In a first aspect, an embodiment of the disclosure provides an oxide composite positive electrode material coated with borate in situ, and the chemical general formula of the material is: γAₓB_{y}O_{z}-NaₐLi_{b}Ni_{c}Cu_{d}MnₑM_{f}O_{2+β};
in the material, Li, Ni, Cu, Mn, and M together occupy the position of transition metal ions in the crystal structure, wherein M is an element for doping and substituting a transition metal site, including one or more non-metal elements from Group IIIA, Group IVA, Group VA, or Group VIA, as well as one or more transition metal elements from the fourth and fifth periods;
a, b, c, d, e, f, 2+β are respectively the mole percentages of corresponding elements, and the components in the chemical general formula satisfy the conservation of charge and stoichiometry, wherein b+c+d+e+f=1, a+b+2c+2d+4e+mf=2(2+β), 0.67≤a≤1, 0<b≤0.2, 0<c≤0.65, 0<d≤0.28, 0<e≤0.65, −0.05≤β≤0.05, and m is the valence state of M;
the space group of the layered oxide composite positive electrode material is P63/mmc or P63/mcm or R3̅m, and the corresponding structure is a P2 phase or an O3 phase; and
AₓB_{y}O_{z} is a coating layer that has a needle-like structure and is generated in situ on the surface of NaₐLi_{b}Ni_{c}Cu_{d}MnₑM_{f}O_{2+β}, being formed by, during a sintering process, coating a material precursor and a layered oxide precursor for generating NaₐLi_{b}Ni_{c}Cu_{d}MnₑM_{f}O_{2+β}, wherein γ is the mass fraction of the coating material precursor in the layered oxide precursor, 0.1 wt %≤γ≤10 wt %, A is Li and/or Na, 0<x≤3, 0<y≤10, 0<z≤15.

Preferably, the coating material precursor is boron oxide or boric acid, and the coating material precursor in a molten state forms AₓB_{y}O_{z} with part of sodium salts and/or lithium salts in the layered oxide precursor.

In a second aspect, an embodiment of the disclosure provides a preparation method of the oxide composite positive electrode material coated with borate in situ as described in the first aspect, which is a solid-phase method, comprising:
mixing a layered oxide precursor and a coating material precursor accounting for 0.1 wt %-1⁰ wt % of the total mass of the layered oxide precursor in proportion to form a positive electrode material precursor, wherein the coating material precursor is boron oxide or boric acid, the layered oxide precursor comprises sodium carbonate with a required sodium stoichiometry of 100 wt %-110 wt %, lithium carbonate with a required sodium stoichiometry of 100 wt %-110 wt %, oxides of nickel, copper, and manganese, and oxides or carbonates of M with a required stoichiometry, and M is an element for doping and substituting a transition metal site, including one or more non-metal elements from Group IIIA, Group IVA, Group VA, or Group VIA, as well as one or more transition metal elements from the fourth and fifth periods;
uniformly mixing the positive electrode material precursor by a ball milling method to obtain precursor powder;
placing the precursor powder in a muffle furnace or a tube furnace, and performing heat treatment for 2-24 hours in an air or oxygen atmosphere of 600-1000° C.; and
grinding the powder obtained after heat treatment to generate the oxide composite positive electrode material coated with borate in situ.

In a third aspect, an embodiment of the disclosure provides a preparation method of the oxide composite positive electrode material coated with borate in situ as described in the first aspect, which is a spray-drying method, comprising:
mixing a layered oxide precursor and a coating material precursor accounting for 0.1 Wt %-10 wt % of the total mass of the layered oxide precursor in proportion to form a positive electrode material precursor, wherein the coating material precursor is boron oxide or boric acid, the layered oxide precursor comprises sodium carbonate or sodium nitrate with a required sodium stoichiometry of 100 wt %-110 wt %, lithium carbonate or lithium sodium nitrate with a required sodium stoichiometry of 100 wt %-110 wt %, oxides or nitrates of nickel, copper, and manganese, and oxides or carbonates of M with a required stoichiometry, and M is an element for doping and substituting a transition metal site, including one or more non-metal elements from Group IIIA, Group IVA, Group VA, or Group VIA, as well as one or more transition metal elements from the fourth and fifth periods;
adding ethanol or water to the positive electrode material precursor, and uniformly stirring to form a slurry;
spray-drying the slurry to obtain precursor powder;
placing the precursor powder in a muffle furnace or a tube furnace, and performing heat treatment for 2-24 hours in an air or oxygen atmosphere of 600-1000° C.; and
grinding the powder obtained after heat treatment to generate the oxide composite positive electrode material coated with borate in situ.

In a fourth aspect, an embodiment of the disclosure provides a preparation method of the oxide composite positive electrode material coated with borate in situ as described in the first aspect, which is a combustion method, comprising:
mixing a layered oxide precursor and a coating material precursor accounting for 0.1 wt %-1⁰ wt % of the total mass of the layered oxide precursor in proportion to form a positive electrode material precursor, wherein the coating material precursor is boron oxide or boric acid, the layered oxide precursor comprises sodium nitrate with a required sodium stoichiometry of 100 wt %-110 wt %, lithium nitrate with a required sodium stoichiometry of 100 wt %-110 wt %, nitrates of nickel, copper, and manganese, and nitrates of M with a required stoichiometry, and M is an element for doping and substituting a transition metal site, including one or more non-metal elements from Group IIIA, Group IVA, Group VA, or Group VIA, as well as one or more transition metal elements from the fourth and fifth periods;
adding acetylacetone to the positive electrode material precursor, and uniformly stirring to form a slurry;
drying the slurry to obtain precursor powder;
placing the precursor powder in a muffle furnace or a tube furnace, and performing heat treatment for 2-24 hours in an air or oxygen atmosphere of 600-1000° C.; and
grinding the powder obtained after heat treatment to generate the oxide composite positive electrode material coated with borate in situ.

In a fifth aspect, an embodiment of the disclosure provides a preparation method of the oxide composite positive electrode material coated with borate in situ as described in the first aspect, which is a sol-gel method, comprising:
mixing a layered oxide precursor and a coating material precursor accounting for 0.1 wt %-10 wt % of the total mass of the layered oxide precursor in proportion to form a positive electrode material precursor, wherein the coating material precursor is boron oxide or boric acid, the layered oxide precursor comprises sodium salts with a required sodium stoichiometry of 100 wt %-110 wt %, lithium salts with a required sodium stoichiometry of 100 wt %-110 wt %, nitrates or sulfates of nickel, copper, and manganese, and nitrates or sulfates of M with a required stoichiometry, and M is an element for doping and substituting a transition metal site, including one or more non-metal elements from Group IIIA, Group IVA, Group VA, or Group VIA, as well as one or more transition metal elements from the fourth and fifth periods; and the sodium salts comprise one or more of sodium acetate, sodium nitrate, sodium carbonate or sodium sulfate, and the lithium salts comprise one or more of lithium acetate, lithium nitrate, lithium carbonate or lithium sulfate;
stirring at 50-100° C., adding a proper amount of chelating agent, and evaporating to dry to form a precursor gel;
placing the precursor gel in a crucible, and presintering for 2 hours in an air atmosphere of 200-500° C.;
placing the precursor powder in a muffle furnace or a tube furnace, and performing heat treatment for 2-24 hours in an air or oxygen atmosphere of 600-1000° C.; and
grinding the powder obtained after heat treatment to generate the oxide composite positive electrode material coated with borate in situ.

In a sixth aspect, an embodiment of the disclosure provides a preparation method of the oxide composite positive electrode material coated with borate in situ as described in the first aspect, which is a coprecipitation method, comprising:
dissolving the required stoichiometric amounts of nitrates of nickel, copper, manganese, lithium and M in water in proportion, and mixing to form a precursor solution, wherein M is an element for doping and substituting a transition metal site, including one or more non-metal elements from Group IIIA, Group IVA, Group VA, or Group VIA, as well as one or more transition metal elements from the fourth and fifth periods;
adding the precursor solution dropwise to an ammonia water solution by a peristaltic pump to generate a precipitate;
cleaning the obtained precipitate with deionized water, drying, and uniformly mixing the precipitate with sodium carbonate and a coating material precursor accounting for 0.1 wt %-1⁰ wt % of the total mass of a layered oxide precursor according to the stoichiometric ratio to obtain a precursor, wherein the layered oxide precursor comprises the sodium carbonate and the nitrates of nickel, copper, manganese, lithium and M;
placing the precursor in a crucible or a porcelain boat, and performing heat treatment for 2-24 hours in an air or oxygen atmosphere of 600-1000° C.; and
grinding the powder obtained after heat treatment to generate the oxide composite positive electrode material coated with borate in situ.

In a seventh aspect, an embodiment of the disclosure provides a positive pole piece of a sodium-ion secondary battery, comprising:
a current collector, a conductive additive and a binder applied onto the current collector, and the oxide composite positive electrode material coated with borate in situ as described in the first aspect.

In an eighth aspect, an embodiment of the disclosure provides a sodium-ion secondary battery comprising the positive pole piece as described in the seventh aspect.

In a ninth aspect, an embodiment of the disclosure provides a use of a sodium-ion secondary battery. The sodium-ion secondary battery is applied to large-scale energy storage equipment for electric vehicles, solar power generation, wind power generation, smart grid peak shaving, distributed power stations, backup power sources or communication base stations.

According to the oxide composite positive electrode material coated with borate in situ provided by the disclosure, boron oxide or boric acid is melted at a low temperature and reacts with part of sodium salts and lithium salts in the positive electrode material precursor to form lithium borate or sodium borate with a chemical general formula of AₓB_{y}O_{z} This allows for a uniform and complete coating on the lithium-containing layered oxide positive electrode. When exposed to air, AₓB_{y}O_{z} transforms into a needle-like structure, resulting in a significant reduction in residual alkali generated on the material surface due to air exposure. This transformation greatly enhances stability in an air environment, improves the electrical conductivity and sodium ion diffusion capacity of the material, reduces charge transfer impedance, increases initial charge-discharge efficiency, and improves cycling performance. Consequently, the lithium-containing oxide composite positive electrode material coated with borate in situ demonstrates increased air stability, higher capacity, and improved cycling stability. This material can be placed in air with a relative humidity of 45% RH-60% RH for more than 48 hours and still maintain structural stability.

### BRIEF DESCRIPTION OF THE DRAWINGS

The technical solutions of the embodiments of the disclosure will be described in further detail with reference to the drawings and embodiments.

FIG. 1 is a flowchart of a solid-phase preparation method of an oxide composite positive electrode material coated with borate in situ according to an embodiment of the disclosure;

FIG. 2 is a flowchart of a spray-drying preparation method of an oxide composite positive electrode material coated with borate in situ according to an embodiment of the disclosure;

FIG. 3 is a flowchart of a combustion preparation method of an oxide composite positive electrode material coated with borate in situ according to an embodiment of the disclosure;

FIG. 4 is a flowchart of a sol-gel preparation method of an oxide composite positive electrode material coated with borate in situ according to an embodiment of the disclosure;

FIG. 5 is a flowchart of a coprecipitation preparation method of an oxide composite positive electrode material coated with borate in situ according to an embodiment of the disclosure;

FIG. 6 is an XRD pattern of multiple oxide composite positive electrode materials coated with borate in situ, with different elemental molar percentages according to embodiments of the disclosure;

FIG. 7 is an SEM image of a Na_{1.0}Li_{0.05}Ni_{0.33}Cu_{0.05}Mn_{0.37}Fe_{0.1}Ti_{0.1}O₂ material synthesized by a solid-phase method provided in Embodiment 1 of the disclosure;

FIG. 8 is an SEM image of a 0.5 wt % Li₃BO₃—Na_{1.0}Li_{0.05}Ni_{0.33}Cu_{0.05}Mn_{0.37}Fe_{0.1}Ti_{0.1}O₂ material synthesized by a solid-phase method provided in Embodiment 1 of the disclosure;

FIG. 9 is a comparison diagram of the charge-discharge curves of sodium-ion batteries made of the two aforementioned materials provided in Embodiment 1 of the disclosure at 2.0-4.3 V;

FIG. 10 is a comparison diagram of the cyclic curves of sodium-ion batteries made of the two aforementioned materials provided in Embodiment 1 of the disclosure;

FIG. 11 is an XRD spectrum of an oxide composite positive electrode material coated with borate in situ provided in Embodiment 1 of the disclosure before and after a 48-hour exposure to air with a humidity of 55%; and

FIG. 12 is a comparison diagram of the charge-discharge curves of sodium-ion batteries made of an oxide composite positive electrode material coated with borate in situ provided in Embodiment 1 of the disclosure before and after a 48-hour exposure to air with a humidity of 55%, in the voltage range of 2.0-4.3 V.

### DETAILED DESCRIPTION

The disclosure will be further explained below by referring to drawings and specific embodiments, but it should be understood that these embodiments are only for more detailed explanation, and should not be construed as limiting the disclosure in any way, that is, not intended to limit the scope of protection of the disclosure.

An embodiment of the disclosure provides a layered lithium-containing oxide composite positive electrode material coated with borate in situ, with high air stability, high capacity, and high cycling stability. The chemical general formula of the material is: γAₓB_{y}O_{z}-NaₐLi_{b}Ni_{c}Cu_{d}MnₑM_{f}O_{2+β}. The space group of the layered oxide composite positive electrode material is P63/mmc or P63/mcm or R3̅m, and the corresponding structure is a P2 phase or an O3 phase.

In the material, Li, Ni, Cu, Mn, and M together occupy the position of transition metal ions in the crystal structure, wherein M is an element for doping and substituting a transition metal site, including one or more non-metal elements from Group IIIA, Group IVA, Group VA, or Group VIA, as well as one or more transition metal elements from the fourth and fifth periods;

a, b, c, d, e, f, 2+β are respectively the mole percentages of corresponding elements, and the components in the chemical general formula satisfy the conservation of charge and stoichiometry, wherein b+c+d+e+f=1, a+b+2c+2d+4e+mf=2(2+β), 0.67≤a≤1, 0<b≤0.2, 0<c≤0.65, 0<d≤0.28, 0<e≤0.65, −0.05≤β≤0.05, and m is the valence state of M;

AₓB_{y}O_{z} is a coating layer that is generated in situ on the surface of NaₐLi_{b}Ni_{c}Cu_{d}MnₑM_{f}O_{2+β}, being formed by, during a sintering process, coating a material precursor and a layered oxide precursor for generating NaₐLi_{b}Ni_{c}Cu_{d}MnₑM_{f}O_{2+β}; the coating material precursor is boron oxide or boric acid, and the coating material precursor in a molten state forms AₓB_{y}O_{z} with part of sodium salts and/or lithium salts in the layered oxide precursor; and γ is the mass fraction of the coating material precursor in the layered oxide precursor, 0.1 wt %≤γ≤10 wt %, A is Li and/or Na, 0<x≤3, 0<y≤10, 0<z≤15. The coating layer exhibits a unique morphology, resembling needles upon exposure to air. Prior to air exposure, the coating layer adheres smoothly to the material surface. Due to inevitable contact with air during the production of pole pieces, the morphology of the coating layer undergoes a transition into a needle-like shape, leading to a significant reduction in residual alkali generated on the material surface. This transformation greatly enhances stability in an air environment, improves the electrical conductivity and sodium ion diffusion capacity of the material, reduces charge transfer impedance, increases initial charge-discharge efficiency, improves cycle ability, and notably extends cycle life.

The oxide composite positive electrode material coated with borate in situ provided by the disclosure can be prepared by various methods, which will be explained one by one below.

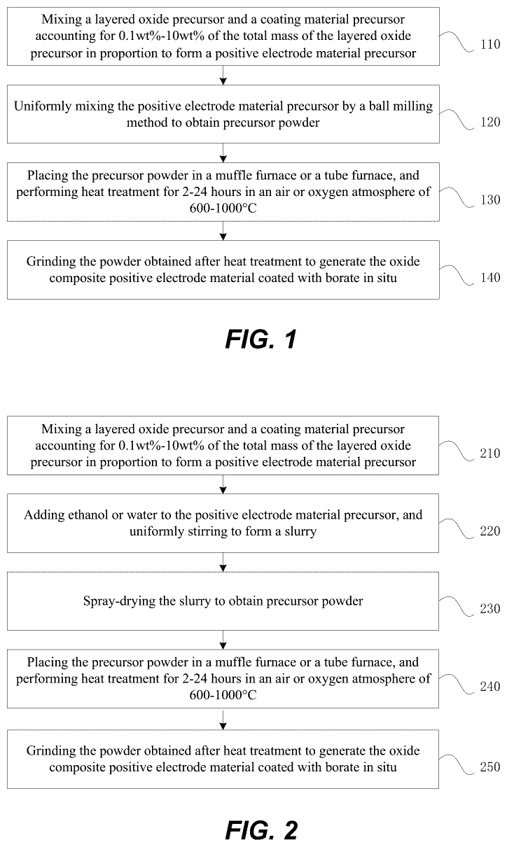

The oxide composite positive electrode material coated with borate in situ can be prepared by a solid-phase method, as shown in FIG. 1, comprising:

Step 110, mixing a layered oxide precursor and a coating material precursor accounting for 0.1 wt %-10 wt % of the total mass of the layered oxide precursor in proportion to form a positive electrode material precursor,
wherein the coating material precursor is boron oxide or boric acid, the layered oxide precursor comprises sodium carbonate with a required sodium stoichiometry of 100 wt %-110 wt %, lithium carbonate with a required sodium stoichiometry of 100 wt %-110 wt %, oxides of nickel, copper, and manganese, and oxides or carbonates of M with a required stoichiometry, and M is an element for doping and substituting a transition metal site, including one or more non-metal elements from Group IIIA, Group IVA, Group VA, or Group VIA, as well as one or more transition metal elements from the fourth and fifth periods;

Step 120, uniformly mixing the positive electrode material precursor by a ball milling method to obtain precursor powder;

Step 130, placing the precursor powder in a muffle furnace or a tube furnace, and performing heat treatment for 2-24 hours in an air or oxygen atmosphere of 600-1000° C.; and

Step 140, grinding the powder obtained after heat treatment to generate the oxide composite positive electrode material coated with borate in situ.

The oxide composite positive electrode material coated with borate in situ can be prepared by a spray-drying method, as shown in FIG. 2, comprising:

Step 210, mixing a layered oxide precursor and a coating material precursor accounting for 0.1 wt %-10 wt % of the total mass of the layered oxide precursor in proportion to form a positive electrode material precursor,
wherein the coating material precursor is boron oxide or boric acid, the layered oxide precursor comprises sodium carbonate or sodium nitrate with a required sodium stoichiometry of 100 wt %-110 wt %, lithium carbonate with a required sodium stoichiometry of 100 wt %-110 wt %, oxides or nitrates of nickel, copper, and manganese, and oxides or carbonates of M with a required stoichiometry, and M is an element for doping and substituting a transition metal site, including one or more non-metal elements from Group IIIA, Group IV, Group VA, or Group VIA, as well as one or more transition metal elements from the fourth and fifth periods;

Step 220, adding ethanol or water to the positive electrode material precursor, and uniformly stirring to form a slurry;

Step 230, spray-drying the slurry to obtain precursor powder;

Step 240, placing the precursor powder in a muffle furnace or a tube furnace, and performing heat treatment for 2-24 hours in an air or oxygen atmosphere of 600-1000° C.; and

Step 250, grinding the powder obtained after heat treatment to generate the oxide composite positive electrode material coated with borate in situ.

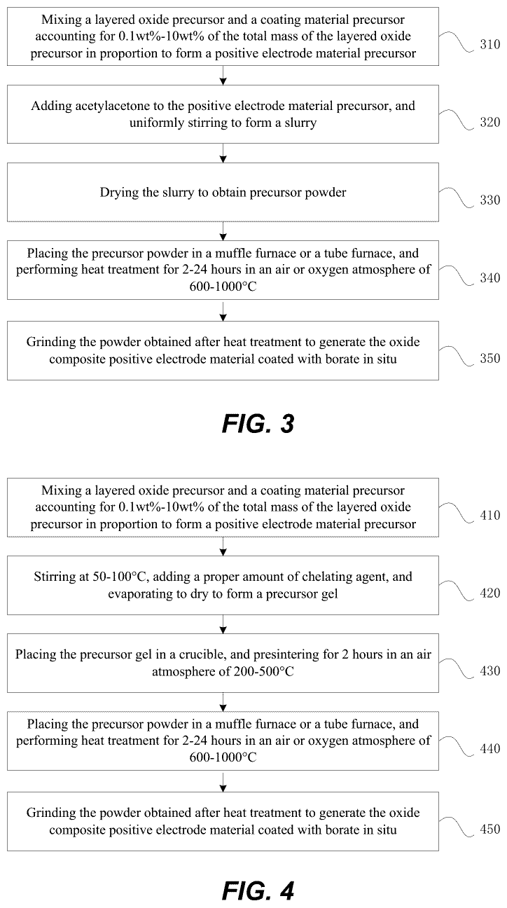

The oxide composite positive electrode material coated with borate in situ can be prepared by a combustion method, as shown in FIG. 3, comprising:

Step 310, mixing a layered oxide precursor and a coating material precursor accounting for 0.1 wt %-10 wt % of the total mass of the layered oxide precursor in proportion to form a positive electrode material precursor,
wherein the coating material precursor is boron oxide or boric acid, the layered oxide precursor comprises sodium nitrate with a required sodium stoichiometry of 100 wt %-110 wt %, lithium nitrate with a required sodium stoichiometry of 100 wt %-110 wt %, and nitrates of nickel, copper, and manganese, and M is an element for doping and substituting a transition metal site, including one or more non-metal elements from Group IIIA, Group IV, Group VA, or Group VIA, as well as one or more transition metal elements from the fourth and fifth periods;

Step 320, adding acetylacetone to the positive electrode material precursor, and uniformly stirring to form a slurry;

Step 330, drying the slurry to obtain precursor powder,
Wherein drying the slurry preferably at 80° C.;

Step 340, placing the precursor powder in a muffle furnace or a tube furnace, and performing heat treatment for 2-24 hours in an air or oxygen atmosphere of 600-1000° C.; and

Step 350, grinding the powder obtained after heat treatment to generate the oxide composite positive electrode material coated with borate in situ.

The oxide composite positive electrode material coated with borate in situ can be prepared by a sol-gel method, as shown in FIG. 4, comprising:

Step 410, mixing a layered oxide precursor and a coating material precursor accounting for 0.1 wt %-10 wt % of the total mass of the layered oxide precursor in proportion to form a positive electrode material precursor,
wherein the coating material precursor is boron oxide or boric acid, the layered oxide precursor comprises sodium salts with a required sodium stoichiometry of 100 wt %-110 wt %, lithium salts with a required sodium stoichiometry of 100 wt %-110 wt %, and nitrates or sulfates of nickel, copper, and manganese, and M is an element for doping and substituting a transition metal site, including one or more non-metal elements from Group IIIA, Group IV, Group VA, or Group VIA, as well as one or more transition metal elements from the fourth and fifth periods; and the sodium salts comprise one or more of sodium acetate, sodium nitrate, sodium carbonate or sodium sulfate, and the lithium salts comprise one or more of lithium acetate, lithium nitrate, lithium carbonate or lithium sulfate;

Step 420, stirring at 50-100° C., adding a proper amount of chelating agent, and evaporating to dry to form a precursor gel;

Step 430, placing the precursor gel in a crucible, and presintering for 2 hours in an air atmosphere of 200-500° C.;

Step 440, placing the precursor powder in a muffle furnace or a tube furnace, and performing heat treatment for 2-24 hours in an air or oxygen atmosphere of 600-1000° C.; and

Step 450, grinding the powder obtained after heat treatment to generate the oxide composite positive electrode material coated with borate in situ.

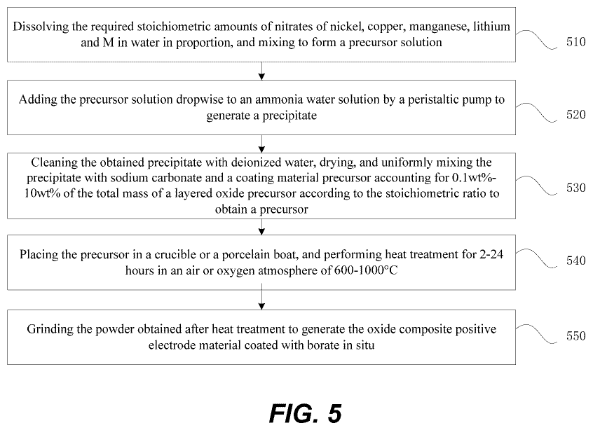

The oxide composite positive electrode material coated with borate in situ can be prepared by a coprecipitation method, as shown in FIG. 5, comprising:

Step 510, dissolving the required stoichiometric amounts of nitrates of nickel, copper, manganese, lithium and M in water in proportion, and mixing to form a precursor solution,
wherein M is an element for doping and substituting a transition metal site, including one or more non-metal elements from Group IIIA, Group IV, Group VA, or Group VIA, as well as one or more transition metal elements from the fourth and fifth periods;

Step 520, adding the precursor solution dropwise to an ammonia water solution by a peristaltic pump to generate a precipitate;

Step 530, cleaning the obtained precipitate with deionized water, drying, and uniformly mixing the precipitate with sodium carbonate and a coating material precursor accounting for 0.1 wt %-10 wt % of the total mass of a layered oxide precursor according to the stoichiometric ratio to obtain a precursor,
wherein the layered oxide precursor comprises the sodium carbonate and the nitrates of nickel, copper, manganese, lithium and M;

Step 540, placing the precursor in a crucible or a porcelain boat, and performing heat treatment for 2-24 hours in an air or oxygen atmosphere of 600-1000° C.; and

Step 550, grinding the powder obtained after heat treatment to generate the oxide composite positive electrode material coated with borate in situ.

The above preparation methods can be used to prepare the layered lithium-containing oxide composite positive electrode material coated with borate in site as described in the above embodiments. The method provided by this embodiment is simple and feasible. It utilizes non-toxic and safe elements, such as sodium, lithium, nickel, copper, and manganese, all of which are abundantly available in the earth's crust, so the manufacturing cost is low. The low manufacturing cost and utilization of safe and non-toxic materials make the method highly suitable for large-scale manufacturing applications.

Through half-cell testing, it has been determined that the oxide composite positive electrode material coated with borate in situ as described in the disclosure not only has high mass specific capacity and specific energy, with a specific capacity 1.5 to 2 times greater than that of commonly used sodium-ion battery positive electrode materials, but also has long cycle life and great practical value. Sodium-ion batteries adopting the oxide composite positive electrode material coated with borate in situ as described in the disclosure can be applied to large-scale energy storage equipment for electric vehicles, solar power generation, wind power generation, smart grid peak shaving, distributed power stations, backup power sources or communication base stations.

In order to better understand the technical solutions provided by the disclosure, the specific process of preparing the oxide composite positive electrode material coated with borate in situ by the methods provided in the above embodiments of the disclosure, the method of its application in a sodium-ion secondary battery, and battery characteristics are described below with several specific examples.

### Embodiment 1

In this embodiment, a lithium-containing layered oxide composite positive electrode material coated with borate in situ was prepared by a solid-phase method, and a lithium-containing layered oxide material was prepared by the same method for comparison.

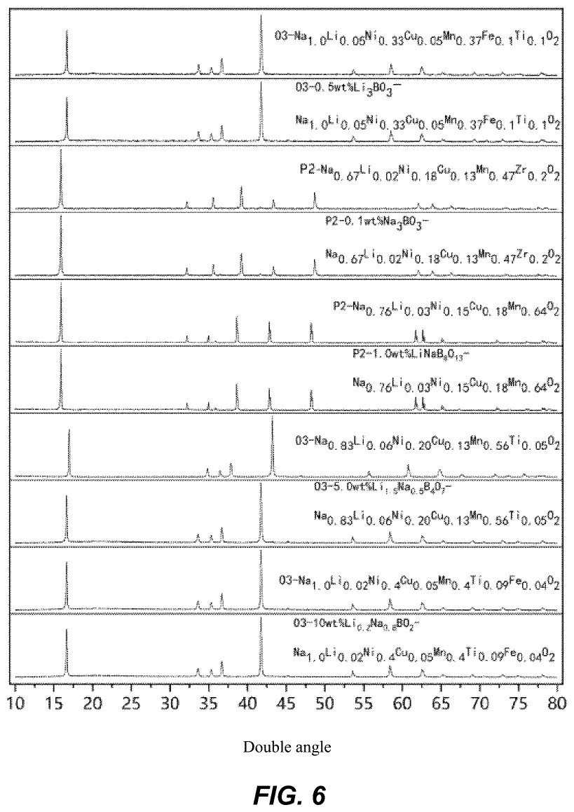

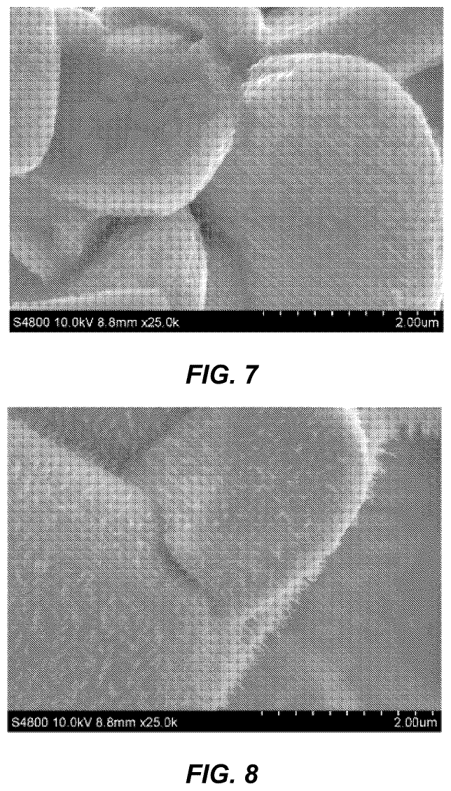

The preparation process of the lithium-containing layered oxide material in this embodiment comprises:
mixing Na₂CO₃ (analytically pure), Li₂CO₃ (analytically pure), NiO (analytically pure), CuO (analytically pure), MnO₂ (analytically pure), Fe₂O₃ (analytically pure) and TiO₂ (analytically pure) according to the required stoichiometric ratio; grinding in an agate mortar for half an hour to obtain a precursor; and transferring the precursor into an Al₂O₃ crucible, and treating it in an oxygen atmosphere of 900° C. in a muffle furnace for 15 hours to obtain a black powder-form layered oxide material Na_{1.0}Li_{0.05}Ni_{0.33}Cu_{0.05}Mn_{0.37}Fe_{0.1}Ti_{0.1}O₂. Please refer to FIG. 6 for its XRD pattern and FIG. 7 for its SEM image.

The preparation process of the lithium-containing layered oxide composite positive electrode material coated with borate in situ comprises:
mixing Na₂CO₃ (analytically pure), Li₂CO₃ (analytically pure), NiO (analytically pure), CuO (analytically pure), MnO₂ (analytically pure), Fe₂O₃ (analytically pure), TiO₂ (analytically pure) and B₂O₃ (analytically pure) according to the required stoichiometric ratio; grinding in an agate mortar for half an hour to obtain a precursor; and transferring the precursor into an Al₂O₃ crucible, and treating it in an oxygen atmosphere of 900° C. in a muffle furnace for 15 hours to obtain a black powder-form 0.5 wt % Li₃BO₃—Na_{1.0}Li_{0.05}Ni_{0.33}Cu_{0.05}Mn_{0.37}Fe_{0.1}Ti_{0.1}O₂.

Please see FIG. 6 for its XRD pattern and FIG. 8 for its SEM image.

According to the XRD patterns, the crystal structures of Na_{1.0}Li_{0.05}Ni_{0.33}Cu_{0.05}Mn_{0.37}Fe_{0.1}Ti_{0.1}O₂ and 0.5 wt % Li₃BO₃—Na_{1.0}Li_{0.05}Ni_{0.33}Cu_{0.05}Mn_{0.37}Fe_{0.1}Ti_{0.1}O₂ are O₃-phase layered oxides.

It can be seen from the two SEM images in FIGS. 7 and 8 that the original material Na_{1.0}Li_{0.05}Ni_{0.33}Cu_{0.05}Mn_{0.37}Fe_{0.1}Ti_{0.1}O₂ contains a lot of blocky residual alkali, which can cause agglomeration of the slurry, leading to difficulties in subsequent battery fabrication. This also results in a decrease in the conductivity and sodium-ion diffusion ability of the material, an increase in charge transfer impedance, a decrease in initial charge-discharge efficiency, and an impact on the cycling stability of the battery. In contrast, the modified composite positive electrode material 0.5 wt % Li₃BO₃—Na_{1.0}Li_{0.05}Ni_{0.33}Cu_{0.05}Mn_{0.37}Fe_{0.1}Ti_{0.1}O₂ exhibits a needle-like structure on the surface, which inhibits the formation of residual alkali on the surface. The slurry made of this material is smooth, thus facilitating battery fabrication and greatly enhancing the cycling stability of the material.

For further comparison, the two kinds of layered oxide materials prepared above were used as active materials of battery positive electrode materials for the preparation of sodium-ion batteries. The steps are as follows: separately mixing the prepared Na_{1.0}Li_{0.05}Ni_{0.33}Cu_{0.05}Mn_{0.37}Fe_{0.1}Ti_{0.1}O₂ powder and 0.5 wt % AₓB_{y}O_{z}—Na_{1.0}Li_{0.05}Ni_{0.33}Cu_{0.05}Mn_{0.37}Fe_{0.1}Ti_{0.1}O₂ powder with acetylene black and binder polyvinylidene fluoride (PVDF) according to the mass ratio of 80:10:10; adding an appropriate amount of N-methylpyrrolidone (NMP) solution; grinding in a dry environment at room temperature to form a slurry; then applying the slurry onto the aluminum foil of a current collector evenly, drying under an infrared lamp, and cutting into (8×8) mm² pole pieces; and drying the pole pieces at 110° C. for 10 hours under vacuum, and then transferring to a glove box for further use.

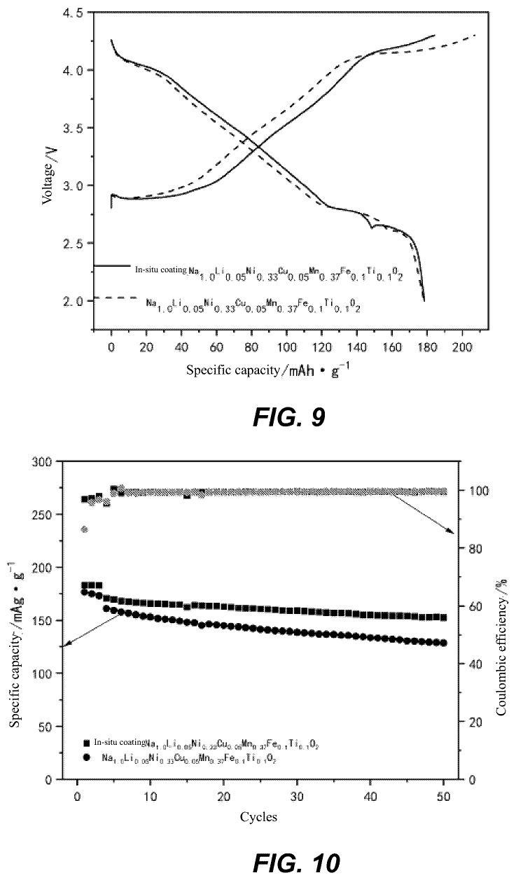

The assembly of simulated batteries was carried out in a glove box under Ar atmosphere. By using metallic sodium as a counter electrode, and a 1M NaClO₄/diethyl carbonate (DEC) solution as an electrolyte, CR2032 button cells were obtained. Charge-discharge tests were performed at C/10 and C/2 current densities by using constant current charge-discharge mode. The 2.0-4.3 V charge-discharge test results under a discharge cutoff voltage of 2.0 V and a charge cutoff voltage of 4.3 V are shown in FIG. 9, and the battery cyclic curves are shown in FIG. 10. It can be observed that although the Na_{1.0}Li_{0.05}Ni_{0.33}Cu_{0.05}Mn_{0.37}Fe_{0.1}Ti_{0.1}O₂ material achieved a discharge capacity of 178.2 mAh/g in the initial cycle, the positive electrode material coated with borate in situ (referred to as in-situ coated material in the figure, the same below) exhibited higher initial coulombic efficiency and better cycling stability.

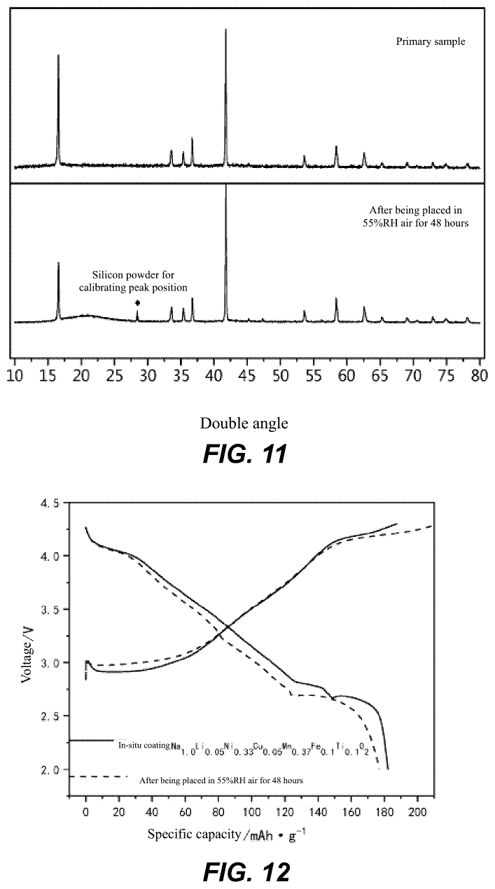

In addition, also compared was the oxide composite positive electrode material coated with borate in situ prepared in Embodiment 1 before and after a 48-hour exposure to air with a humidity of 55%. FIG. 11 shows the XRD spectra before and after the air exposure. The layered oxide materials obtained before and after exposure to humid air were used as active materials of battery positive electrode materials for sodium-ion battery preparation, and electrochemical charge-discharge tests were conducted. The preparation process and testing method were the same as in Embodiment 1, with a test voltage range of 2.0-4.3 V. FIG. 12 shows the charge-discharge test results. From the charge-discharge curves and reversible specific capacity, it can be observed that the effect of air with a humidity of 55% on the material is quite small, further confirming that the presence of the coating layer can enhance the air stability of the material.

### Embodiment 2

In this embodiment, a lithium-containing layered oxide composite positive electrode material coated with borate in situ was prepared by a solid-phase method, and a lithium-containing layered oxide material was prepared by the same method for comparison.

The preparation process of the lithium-containing layered oxide material in this embodiment comprises:
mixing Na₂CO₃ (analytically pure), Li₂CO₃ (analytically pure), NiO (analytically pure), CuO (analytically pure), MnO₂ (analytically pure) and ZrO₂ (analytically pure) according to the required stoichiometric ratio; grinding in an agate mortar for half an hour to obtain a precursor; and transferring the precursor into an Al₂O₃ crucible, and treating it in an oxygen atmosphere of 900° C. in a muffle furnace for 15 hours to obtain a black powder-form layered oxide material Na_{0.67}Li_{0.02}Ni_{0.18}Cu_{0.13}Mn_{0.47}Zr_{0.2}O₂. Please see FIG. 6 for its XRD pattern. The preparation process of the lithium-containing layered oxide composite positive electrode material coated with borate in situ comprises:
mixing Na₂CO₃ (analytically pure), Li₂CO₃ (analytically pure), NiO (analytically pure), CuO (analytically pure), MnO₂ (analytically pure), ZrO₂ (analytically pure) and B₂O₃ (analytically pure) according to the required stoichiometric ratio; grinding in an agate mortar for half an hour to obtain a precursor; and transferring the precursor into an Al₂O₃ crucible, and treating it in an oxygen atmosphere of 900° C. in a muffle furnace for 15 hours to obtain a black powder-form layered oxide material 0.1 wt % Na₃BO₃—Na_{0.67}Li_{0.02}Ni_{0.18}Cu_{0.13}Mn_{0.47}Zr_{0.2}O₂. See FIG. 6 for its XRD pattern.

According to the XRD patterns, the crystal structures of Na_{0.67}Li_{0.02}Ni_{0.18}Cu_{0.13}Mn_{0.47}Zr_{0.2}O₂ and 0.1 wt % Na₃BO₃— Na_{0.67}Li_{0.02}Ni_{0.18}Cu_{0.13}Mn_{0.47}Zr_{0.2}O₂ are P2-phase layered oxides.

The layered oxide material prepared above was used as an active material of battery positive electrode materials for sodium-ion battery preparation, and electrochemical charge-discharge tests were conducted. The preparation process and testing method were the same as in Embodiment 1, with a test voltage range of 2.0-4.3 V. The reversible specific capacity of the material is shown in Table 1.

### Embodiment 3

In this embodiment, a lithium-containing layered oxide composite positive electrode material coated with borate in situ was prepared by a solid-phase method, and a lithium-containing layered oxide material was prepared by the same method for comparison.

The preparation process of the lithium-containing layered oxide material in this embodiment comprises:
mixing Na₂CO₃ (analytically pure), Li₂CO₃ (analytically pure), NiO (analytically pure), CuO (analytically pure) and MnO₂ (analytically pure) according to the required stoichiometric ratio; grinding in an agate mortar for half an hour to obtain a precursor; and transferring the precursor into an Al₂O₃ crucible, and treating it in an oxygen atmosphere of 900° C. in a muffle furnace for 15 hours to obtain a black powder-form layered oxide material Na_{0.76}Li_{0.03}Ni_{0.15}Cu_{0.18}Mn_{0.64}O₂. See FIG. 6 for its XRD pattern.

The preparation process of the lithium-containing layered oxide composite positive electrode material coated with borate in situ comprises: mixing Na₂CO₃ (analytically pure), Li₂CO₃ (analytically pure), NiO (analytically pure), CuO (analytically pure), MnO₂ (analytically pure) and B₂O₃ (analytically pure) according to the required stoichiometric ratio; grinding in an agate mortar for half an hour to obtain a precursor; and transferring the precursor into an Al₂O₃ porcelain combustion boat, and treating it in an air atmosphere of 900° C. in a tube furnace for 15 hours to obtain a black powder-form layered oxide material 1.0 wt % LiNaB₈O₁₃—Na_{0.76}Li_{0.03}Ni_{0.15}Cu_{0.18}Mn_{0.64}O₂. See FIG. 6 for its XRD pattern.

According to the XRD patterns, the crystal structures of Na_{0.76}Li_{0.03}Ni_{0.15}Cu_{0.18}Mn_{0.64}O₂ and 1.0 wt % LiNaB₈O₁₃—Na_{0.76}Li_{0.03}Ni_{0.15}Cu_{0.18}Mn_{0.64}O₂ are P2-phase layered oxides.

The layered oxide material prepared above was used as an active material of battery positive electrode materials for sodium-ion battery preparation, and electrochemical charge-discharge tests were conducted. The preparation process and testing method were the same as in Embodiment 1, with a test voltage range of 2.0-4.3 V. The reversible specific capacity of the material is shown in Table 1.

### Embodiment 4

In this embodiment, a lithium-containing layered oxide composite positive electrode material coated with borate in situ was prepared by a solid-phase method, and a lithium-containing layered oxide material was prepared by the same method for comparison.

The preparation process of the lithium-containing layered oxide material in this embodiment comprises:
mixing Na₂CO₃ (analytically pure), Li₂CO₃ (analytically pure), NiO (analytically pure), CuO (analytically pure), MnO₂ (analytically pure) and TiO₂ (analytically pure) according to the required stoichiometric ratio; grinding in an agate mortar for half an hour to obtain a precursor; and transferring the precursor into an Al₂O₃ crucible, and treating it in an oxygen atmosphere of 900° C. in a muffle furnace for 15 hours to obtain a black powder-form layered oxide material Na_{0.83}Li_{0.06}Ni_{0.20}Cu_{0.13}Mn_{0.56}Ti_{0.05}O₂. Please see FIG. 6 for its XRD pattern.

The preparation process of the lithium-containing layered oxide composite positive electrode material coated with borate in situ comprises: mixing Na₂CO₃ (analytically pure), Li₂CO₃ (analytically pure), NiO (analytically pure), CuO (analytically pure), MnO₂ (analytically pure), TiO₂ (analytically pure) and B₂O₃ (analytically pure) according to the required stoichiometric ratio; grinding in an agate mortar for half an hour to obtain a precursor; and transferring the precursor into an Al₂O₃ porcelain combustion boat, and treating it in an oxygen atmosphere of 900° C. in a tube furnace for 15 hours to obtain a black powder-form layered oxide material 5.0 wt % Li_{1.5}Na_{0.5}B₄O₇—Na_{0.83}Li_{0.06}Ni_{0.20}Cu_{0.13}Mn_{0.56}Ti_{0.05}O₂. See FIG. 6 for its XRD pattern.

According to the XRD patterns, the crystal structures of Na_{0.83}Li_{0.06}Ni_{0.20}Cu_{0.13}Mn_{0.56}Ti_{0.05}O₂ and 5.0 wt % Li_{1.5}Na_{0.5}B₄O₇—Na_{0.83}Li_{0.06}Ni_{0.20}Cu_{0.13}Mn_{0.56}Ti_{0.05}O₂ are O3-phase layered oxides.

The layered oxide material prepared above was used as an active material of battery positive electrode materials for sodium-ion battery preparation, and electrochemical charge-discharge tests were conducted. The preparation process and testing method were the same as in Embodiment 1, with a test voltage range of 2.0-4.3 V. The reversible specific capacity of the material is shown in Table 1.

### Embodiment 5

In this embodiment, a lithium-containing layered oxide composite positive electrode material coated with borate in situ was prepared by a solid-phase method, and a lithium-containing layered oxide material was prepared by the same method for comparison.

The preparation process of the lithium-containing layered oxide material in this embodiment comprises:

mixing Na₂CO₃ (analytically pure), Li₂CO₃ (analytically pure), NiO (analytically pure), CuO (analytically pure), MnO₂ (analytically pure) and TiO₂ (analytically pure) according to the required stoichiometric ratio; grinding in an agate mortar for half an hour to obtain a precursor; and transferring the precursor into an Al₂O₃ crucible, and treating it in an oxygen atmosphere of 900° C. in a muffle furnace for 15 hours to obtain a black powder-form layered oxide material Na_{1.0}Li_{0.02}Ni_{0.4}Cu_{0.05}Mn_{0.4}Ti_{0.09}Fe_{0.04}O₂. Please see FIG. 6 for its XRD pattern.

The preparation process of the lithium-containing layered oxide composite positive electrode material coated with borate in situ comprises:
mixing Na₂CO₃ (analytically pure), Li₂CO₃ (analytically pure), NiO (analytically pure), CuO (analytically pure), MnO₂ (analytically pure), AlO (analytically pure) and B₂O₃ (analytically pure) according to the required stoichiometric ratio; grinding in an agate mortar for half an hour to obtain a precursor; and transferring the precursor into an Al₂O₃ porcelain combustion boat, and treating it in an oxygen atmosphere of 900° C. in a tube furnace for 15 hours to obtain a black powder-form layered oxide material 10 wt % Li_{0.2}Na_{0.8}BO₂—Na_{1.0}Li_{0.02}Ni_{0.4}Cu_{0.05}Mn_{0.4}Ti_{0.09}Fe_{0.04}O₂.

Please see FIG. 6 for its XRD pattern.

According to the XRD patterns, the crystal structures of Na_{1.0}Li_{0.02}Ni_{0.4}Cu_{0.05}Mn_{0.4}Ti_{0.09}Fe_{0.04}O₂ and 10 wt % Li_{0.2}Na_{0.8}BO₂—Na_{1.0}Li_{0.02}Ni_{0.4}Cu_{0.05}Mn_{0.4}Ti_{0.09}Fe_{0.04}O₂ are O3-phase layered oxides.

The layered oxide material prepared above was used as an active material of battery positive electrode materials for sodium-ion battery preparation, and electrochemical charge-discharge tests were conducted. The preparation process and testing method were the same as in Embodiment 1, with a test voltage range of 2.0-4.3 V. The reversible specific capacity of the material is shown in Table 1.

TABLE 1

| | | | 2.0-4.3 V |
|---|---|---|---|
| | | | Capacity |
| | | Reversible | retention |
| | | specific | rate after |
| | | capacity | 50 cycles |
| Embodiment | Composition | (mAh/g) | at 0.5 C |
| 1 | Na_{1.0}Li_{0.05}Ni_{0.33}Cu_{0.05}Mn_{0.37}Fe_{0.1}Ti_{0.1}O₂ | 178.2 | 79.9% |
| (comparison) | | | |
| 1 | 0.5 wt % Li₃BO₃—Na_{1.0}Li_{0.05}Ni_{0.33}Cu_{0.05}Mn_{0.37}Fe_{0.1}Ti_{0.1}O₂ | 178.5 | 89.7% |
| 2 | Na_{0.67}Li_{0.02}Ni_{0.18}Cu_{0.13}Mn_{0.47}Zr_{0.2}O₂ | 91.4 | 88.5% |
| (comparison) | | | |
| 2 | 0.1 wt % Na₃BO₃—Na_{0.67}Li_{0.02}Ni_{0.18}Cu_{0.13}Mn_{0.47}Zr_{0.2}O₂ | 92.3 | 96.3% |
| 3 | Na_{0.76}Li_{0.03}Ni_{0.15}Cu_{0.18}Mn_{0.64}O₂ | 121.0 | 85.7% |
| (comparison) | | | |
| 3 | 1.0 wt % LiNaB₈O₁₃—Na_{0.76}Li_{0.03}Ni_{0.15}Cu_{0.18}Mn_{0.64}O₂ | 123.9 | 92.7% |
| 4 | Na_{0.83}Li_{0.06}Ni_{0.20}Cu_{0.13}Mn_{0.56}Ti_{0.05}O₂ | 143.8 | 80.1% |
| (comparison) | | | |
| 4 | 5.0 wt % Li_{1.5}Na_{0.5}B₄O₇—Na_{0.83}Li_{0.06}Ni_{0.20}Cu_{0.13}Mn_{0.56}Ti_{0.05}O₂ | 147.4 | 87.8% |
| 5 | Na_{1.0}Li_{0.02}Ni_{0.4}Cu_{0.05}Mn_{0.4}Ti_{0.09}Fe_{0.04}O₂ | 190.5 | 72.6% |
| (comparison) | | | |
| 5 | 10 wt % Li_{0.2}Na_{0.8}BO₂—Na_{1.0}Li_{0.02}Ni_{0.4}Cu_{0.05}Mn_{0.4}Ti_{0.09}Fe_{0.04}O₂ | 193.7 | 85.4% |

By comparison, it can be seen that the composite positive electrode material coated with borate in situ obtained by means of in-situ coating in the disclosure not only has high capacity, but also significantly improves the cycling capacity retention rate. After the material comes into contact with air, the morphology of the coating layer changes from smooth to needle-like, significantly reducing the residual alkali on the material surface, greatly improving the stability in the air, enhancing the electrical conductivity and sodium ion diffusion capacity of the material, reducing charge transfer impedance, increasing initial charge-discharge efficiency, improving cycle ability, and notably extending cycle life.

Although the above embodiments only illustrate the concrete implementation of the scheme of the disclosure by taking the solid-phase method as an example, the spray-drying, combustion, sol-gel and coprecipitation preparation methods provided above are all well-known methods for those skilled in the art, who can realize the technical scheme of the disclosure without paying creative labor according to the process steps of the above preparation methods provided by the disclosure.

The above-mentioned specific embodiments further explain the purpose, technical solution and beneficial effects of the disclosure in detail. It should be understood that the above are only specific embodiments of the invention and are not used to limit the scope of protection of the disclosure. Any modification, equivalent substitution, improvement, etc., made within the spirit and principles of the disclosure should be included in the scope of protection of the disclosure.

1. An oxide composite positive electrode material coated with borate in situ, comprising:
a chemical general formula: γAₓB_{y}O_{z}-NaₐLi_{b}Ni_{c}Cu_{d}MnₑM_{f}O_{2+β}, wherein:
Li, Ni, Cu, Mn, and M together occupy the position of transition metal ions in a crystal structure, and M is an element for doping and substituting a transition metal site, including one or more non-metal elements from Group IIIA, Group IV, Group VA, or Group VIA, as well as one or more transition metal elements from fourth and fifth periods;
a, b, c, d, e, f, 2+β are respectively mole percentages of corresponding elements, the components in the chemical general formula satisfying conservation of charge and stoichiometry, wherein b+c+d+e+f=1, a+b+2c+2d+4e+mf=2(2+β), 0.67≤a≤1, 0<b≤0.2, 0<c≤0.65, 0<d≤0.28, 0<e≤0.65, −0.05≤β≤0.05, and m is the valence state of M;
a space group P63/mmc or P63/mcm or R3̅m, and a corresponding structure is a P2 phase or an O3 phase; and
AₓB_{y}O_{z} is a coating layer that has a needle-like structure and is generated in situ on a surface of NaₐLi_{b}Ni_{c}Cu_{d}MnₑM_{f}O_{2+β}, which is formed by, during a sintering process, a material precursor and a layered oxide precursor for generating the NaₐLi_{b}Ni_{c}Cu_{d}MnₑM_{f}O_{2+β}, wherein γ is a mass fraction of a coating material precursor in the layered oxide precursor, 0.1 wt %≤γ≤10 wt %, A is Li and/or Na, 0<x≤3, 0<y≤10, 0<z≤15.

2. The oxide composite positive electrode material coated with borate in situ of claim 1, wherein the coating material precursor is boron oxide or boric acid, and AₓB_{y}O_{z} is formed by the coating material precursor in a molten state with part of sodium salts and/or lithium salts in the layered oxide precursor.

3. A solid-phase preparation method for the oxide composite positive electrode material coated with borate in situ of claim 1, the method comprising:
mixing the layered oxide precursor and the coating material precursor accounting for 0.1 wt %-10 wt % of the total mass of the layered oxide precursor in proportion to form a positive electrode material precursor, wherein the coating material precursor is boron oxide or boric acid, the layered oxide precursor comprises sodium carbonate with a required sodium stoichiometry of 100 wt %-110 wt %, lithium carbonate with a required sodium stoichiometry of 100 wt %-110 wt %, oxides of nickel, copper, and manganese, and oxides or carbonates of M with a required stoichiometry;
uniformly mixing the positive electrode material precursor by a ball milling method to obtain a precursor powder;
placing the precursor powder in a muffle furnace or a tube furnace, and performing heat treatment for 2-24 hours in an air or oxygen atmosphere of 600-1000° C.; and
grinding the precursor powder after the heat treatment to generate the oxide composite positive electrode material coated with borate in situ.

4. A spray-drying preparation method for the oxide composite positive electrode material coated with borate in situ of claim 1, the method comprising:
mixing the layered oxide precursor and the coating material precursor accounting for 0.1 wt %-10 wt % of the total mass of the layered oxide precursor in proportion to form a positive electrode material precursor, wherein the coating material precursor is boron oxide or boric acid, the layered oxide precursor comprises sodium carbonate or sodium nitrate with a required sodium stoichiometry of 100 wt %-110 wt %, lithium carbonate with a required sodium stoichiometry of 100 wt %-110 wt %, oxides or nitrates of nickel, copper, and manganese, and oxides or carbonates of M with a required stoichiometry;
adding ethanol or water to the positive electrode material precursor, and uniformly stirring to form a slurry;
spray-drying the slurry to obtain a precursor powder;
placing the precursor powder in a muffle furnace or a tube furnace, and performing heat treatment for 2-24 hours in an air or oxygen atmosphere of 600-1000° C.; and
grinding the precursor powder obtained after the heat treatment to generate the oxide composite positive electrode material coated with borate in situ.

5. A combustion preparation method for the oxide composite positive electrode material coated with borate in situ of claim 1, the method comprising:
mixing the layered oxide precursor and the coating material precursor accounting for 0.1 wt %-10 wt % of the total mass of the layered oxide precursor in proportion to form a positive electrode material precursor, wherein the coating material precursor is boron oxide or boric acid, the layered oxide precursor comprises sodium nitrate with a required sodium stoichiometry of 100 wt %-110 wt %, lithium nitrate with a required sodium stoichiometry of 100 wt %-110 wt %, nitrates of nickel, copper, and manganese, and nitrates of M with a required stoichiometry;
adding acetylacetone to the positive electrode material precursor, and uniformly stirring to form a slurry;
drying the slurry to obtain a precursor powder;
placing the precursor powder in a muffle furnace or a tube furnace, and performing heat treatment for 2-24 hours in an air or oxygen atmosphere of 600-1000° C.; and
grinding the precursor powder obtained after the heat treatment to generate the oxide composite positive electrode material coated with borate in situ.

6. A sol-gel preparation method for the oxide composite positive electrode material coated with borate in situ of claim 1, the method comprising:
mixing the layered oxide precursor and the coating material precursor accounting for 0.1%-10 wt % of the total mass of the layered oxide precursor in proportion to form a positive electrode material precursor, wherein the coating material precursor is boron oxide or boric acid, the layered oxide precursor comprises sodium salts with a required sodium stoichiometry of 100 wt %-110 wt %, lithium salts with a required sodium stoichiometry of 100 wt %-110 wt %, nitrates or sulfates of nickel, copper, and manganese, and nitrates or sulfates of M with a required stoichiometry, and the sodium salts comprise one or more of sodium acetate, sodium nitrate, sodium carbonate or sodium sulfate, and the lithium salts comprise one or more of lithium acetate, lithium nitrate, lithium carbonate or lithium sulfate;
stirring at 50-100° C., adding a proper amount of chelating agent, and evaporating to dry to form a precursor gel;
placing the precursor gel in a crucible, and presintering for 2 hours in an air atmosphere of 200-500° C. to form a precursor powder;
placing the precursor powder in a muffle furnace or a tube furnace, and performing heat treatment for 2-24 hours in an air or oxygen atmosphere of 600-1000° C.; and
grinding the precursor powder obtained after the heat treatment to generate the oxide composite positive electrode material coated with borate in situ.

7. A coprecipitation preparation method for the oxide composite positive electrode material coated with borate in situ of claim 1, the method comprising:
dissolving the required stoichiometric amounts of nitrates of nickel, copper, manganese, lithium and M in water in proportion, and mixing to form a precursor solution;
adding the precursor solution dropwise to an ammonia water solution by a peristaltic pump to generate a precipitate;
cleaning the obtained precipitate with deionized water, drying, and uniformly mixing the precipitate with sodium carbonate and the coating material precursor accounting for 0.1 wt %-10 wt % of the total mass of a layered oxide precursor according to the stoichiometric ratio to obtain a precursor, wherein the layered oxide precursor comprises the sodium carbonate and the nitrates of nickel, copper, manganese, lithium and M;
placing the precursor in a crucible or a porcelain combustion boat, and performing heat treatment for 2-24 hours in an air or oxygen atmosphere of 600-1000° C. to form a powder; and
grinding the powder obtained after the heat treatment to generate the oxide composite positive electrode material coated with borate in situ.

8. A positive pole piece of a sodium-ion secondary battery, comprising:
a current collector, a conductive additive and a binder applied onto the current collector, and the oxide composite positive electrode material coated with borate in situ of claim 1.

9. A sodium-ion secondary battery comprising the positive pole piece of claim 8.

10. A use of the sodium-ion secondary battery of claim 9, wherein the sodium-ion secondary battery is applied to large-scale energy storage equipment for electric vehicles, solar power generation, wind power generation, smart grid peak shaving, distributed power stations, backup power sources or communication base stations.

11. A spray-drying preparation method for the oxide composite positive electrode material coated with borate in situ of claim 2, the method comprising:
mixing the layered oxide precursor and the coating material precursor accounting for 0.1 wt %-10 wt % of the total mass of the layered oxide precursor in proportion to form a positive electrode material precursor, wherein the coating material precursor is boron oxide or boric acid, the layered oxide precursor comprises sodium carbonate or sodium nitrate with a required sodium stoichiometry of 100 wt %-110 wt %, lithium carbonate with a required sodium stoichiometry of 100 wt %-110 wt %, oxides or nitrates of nickel, copper, and manganese, and oxides or carbonates of M with a required stoichiometry;
adding ethanol or water to the positive electrode material precursor, and uniformly stirring to form a slurry;
spray-drying the slurry to obtain a precursor powder;
placing the precursor powder in a muffle furnace or a tube furnace, and performing heat treatment for 2-24 hours in an air or oxygen atmosphere of 600-1000° C.; and
grinding the precursor powder obtained after the heat treatment to generate the oxide composite positive electrode material coated with borate in situ.

12. A combustion preparation method for the oxide composite positive electrode material coated with borate in situ of claim 2, the method comprising:
mixing the layered oxide precursor and the coating material precursor accounting for 0.1 wt %-10 wt % of the total mass of the layered oxide precursor in proportion to form a positive electrode material precursor, wherein the coating material precursor is boron oxide or boric acid, the layered oxide precursor comprises sodium nitrate with a required sodium stoichiometry of 100 wt %-110 wt %, lithium nitrate with a required sodium stoichiometry of 100 wt %-110 wt %, nitrates of nickel, copper, and manganese, and nitrates of M with a required stoichiometry;
adding acetylacetone to the positive electrode material precursor, and uniformly stirring to form a slurry;
drying the slurry to obtain a precursor powder;
placing the precursor powder in a muffle furnace or a tube furnace, and performing heat treatment for 2-24 hours in an air or oxygen atmosphere of 600-1000° C.; and
grinding the precursor powder obtained after the heat treatment to generate the oxide composite positive electrode material coated with borate in situ.

13. A sol-gel preparation method for the oxide composite positive electrode material coated with borate in situ of claim 2, the method is a sol-gel comprising:
mixing the layered oxide precursor and the coating material precursor accounting for 0.1%-10 wt % of the total mass of the layered oxide precursor in proportion to form a positive electrode material precursor, wherein the coating material precursor is boron oxide or boric acid, the layered oxide precursor comprises sodium salts with a required sodium stoichiometry of 100 wt %-110 wt %, lithium salts with a required sodium stoichiometry of 100 wt %-110 wt %, nitrates or sulfates of nickel, copper, and manganese, and nitrates or sulfates of M with a required stoichiometry, and the sodium salts comprise one or more of sodium acetate, sodium nitrate, sodium carbonate or sodium sulfate, and the lithium salts comprise one or more of lithium acetate, lithium nitrate, lithium carbonate or lithium sulfate;
stirring at 50-100° C., adding a proper amount of chelating agent, and evaporating to dry to form a precursor gel;
placing the precursor gel in a crucible, and presintering for 2 hours in an air atmosphere of 200-500° C. to form a precursor powder;
placing the precursor powder in a muffle furnace or a tube furnace, and performing heat treatment for 2-24 hours in an air or oxygen atmosphere of 600-1000° C.; and
grinding the precursor powder obtained after the heat treatment to generate the oxide composite positive electrode material coated with borate in situ.

14. A coprecipitation preparation method for the oxide composite positive electrode material coated with borate in situ of claim 2, the method comprising:
dissolving the required stoichiometric amounts of nitrates of nickel, copper, manganese, lithium and M in water in proportion, and mixing to form a precursor solution;
adding the precursor solution dropwise to an ammonia water solution by a peristaltic pump to generate a precipitate;
cleaning the obtained precipitate with deionized water, drying, and uniformly mixing the precipitate with sodium carbonate and the coating material precursor accounting for 0.1 wt %-10 wt % of the total mass of a layered oxide precursor according to the stoichiometric ratio to obtain a precursor, wherein the layered oxide precursor comprises the sodium carbonate and the nitrates of nickel, copper, manganese, lithium and M;
placing the precursor in a crucible or a porcelain combustion boat, and performing heat treatment for 2-24 hours in an air or oxygen atmosphere of 600-1000° C. to form a powder; and
grinding the powder obtained after the heat treatment to generate the oxide composite positive electrode material coated with borate in situ.

15. A positive pole piece of a sodium-ion secondary battery, comprising:
a current collector, a conductive additive and a binder applied onto the current collector, and the oxide composite positive electrode material coated with borate in situ of claim 2.
